(19) United States
(12) Patent Application Publication
(10) Pub. No.: US 2014/0379846 A1
(43) Pub. Date: Dec. 25, 2014

(54) TECHNIQUE FOR COORDINATING MEMORY ACCESS REQUESTS FROM CLIENTS IN A MOBILE DEVICE

(71) Applicant: NVIDIA CORPORATION, Santa Clara, CA (US)

(72) Inventors: Mrudula KANURI, Bangalore (IN); Sreenivas KRISHNAN, Santa Clara, CA (US)

(73) Assignee: NVIDIA CORPORATION, Santa Clara, CA (US)

(21) Appl. No.: 13/923,201

(22) Filed: Jun. 20, 2013

(51) Int. Cl. H04L 29/08

(52) U.S. Cl. CPC H04L 67/1097
USPC 709/216

(57) ABSTRACT

A memory access pipeline within a subsystem is configured to manage memory access requests that are issued by clients of the subsystem. The memory access pipeline is capable of providing a software baseband controller client with sufficient memory bandwidth to initiate and maintain network connections. The memory access pipeline includes a tiered snap arbiter that prioritizes memory access requests. The memory access pipeline also includes a digital differential analyzer that monitors the amount of bandwidth consumed by each client and causes the tiered snap arbiter to buffer memory access requests associated with clients consuming excessive bandwidth. The memory access pipeline also includes a transaction store and latency analyzer configured to buffer pages associated with the baseband controller and to expedite memory access requests issued by the baseband controller when the latency associated with those requests exceeds a pre-set value.

### BACKGROUND OF THE INVENTION

1. Field of the Invention

The present invention generally relates to mobile devices and, more specifically, to a technique for coordinating memory access requests for clients in a mobile device.

2. Description of the Related Art

A conventional mobile computing device, such as a cell phone or tablet computer, typically includes a variety of different “clients” that represent hardware or software entities operating within the device. These clients generally consume system resources, including processor cycles and memory bandwidth, in order perform various tasks associated with the overall operation of the mobile device. One such client is a modem that allows the mobile device to connect to a network. The network could be a cellular network or a wireless network, among other types of networks. Once connected to the network, the mobile device is capable of accessing the Internet, interacting with other devices across the network, and so forth, by performing network transactions via the modem.

In order to maintain a network connection, a conventional modem typically needs to respond to network events within a certain amount of time. If a network event occurs and the modem cannot respond within that amount of time, the network connection may be lost. In situations where the modem is connected to a cellular network, losing that connection could result in a dropped call, which is very undesirable from a user perspective. As such, various solutions exist for ensuring that the modem is capable of responding to network events in a timely manner. In particular, conventional modems are oftentimes designed as discrete components that operate more or less separately from other clients in the mobile device and do not require significant consumption of processor resources. In addition, conventional modems are usually provided with dedicated dynamic random-access memory (DRAM) to avoid situations where the modem is starved for memory bandwidth and cannot respond to network events.

However, these solutions are problematic because the discrete modem and dedicated DRAM consume precious die area in the mobile device. Also, providing dedicated DRAM requires a dedicated memory interface, which consumes additional die area. These various additional components also increase the power consumption of the mobile device, which is very problematic in and of itself.

Accordingly, what is needed in the art is a more effective way to integrate the modem into a mobile device.

### SUMMARY OF THE INVENTION

One embodiment of the present invention includes a computer-implemented method for coordinating memory access requests issued by a plurality of clients, including receiving a first memory access request from a first client included in the plurality of clients, where the first client is configured to initiate and maintain a network connection between a computing device that includes the plurality of clients and a network external to the computing device, receiving a second memory access request from a second client included in the plurality of clients, determining an order for servicing the first memory access request and the second memory access request, causing a memory unit to access a first portion of data to process the first memory access request according to the order, and causing the memory unit to access a second portion of data to process the second memory access request according to the order.

An advantage of the disclosed approach is that the first client does not require separate memory or a separate memory interface in order to acquire sufficient memory bandwidth to initiate and maintain network connections. Accordingly, the disclosed computing device may have a reduced size as well as decreased power requirements compared to prior art designs.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 is a block diagram of a system configured to coordinate memory access requests from various clients, according to one embodiment of the present invention;

FIG. 4A is a more detailed block diagram illustrating the tiered snap arbiter (TSA) and digital differential analyzer (DDA) of FIG. 3, according to one embodiment of the present invention;

FIG. 4B is a more detailed block diagram illustrating the translation store and latency analyzer (TSLA) of FIG. 3, according to one embodiment of the present invention;

FIG. 5 is a flow diagram of method steps for arbitrating memory access requests from multiple clients, according to one embodiment of the present invention;

FIG. 6 is a flow diagram of method steps for generating a control mask that causes a TSA to buffer memory access requests from certain clients, according to one embodiment of the present invention;

FIG. 7 is a flow diagram of method steps for handling a memory access request from a baseband controller (BBC), according to one embodiment of the present invention; and

FIG. 8 is a flow diagram of method steps for decreasing the latency associated with memory access requests from a BBC, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

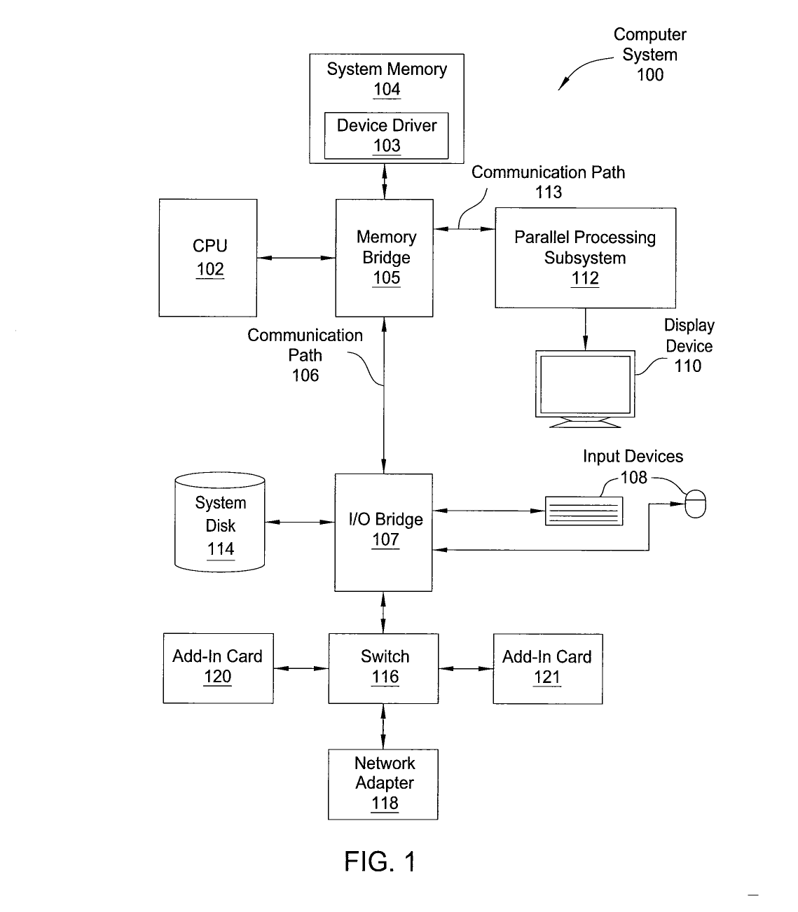

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

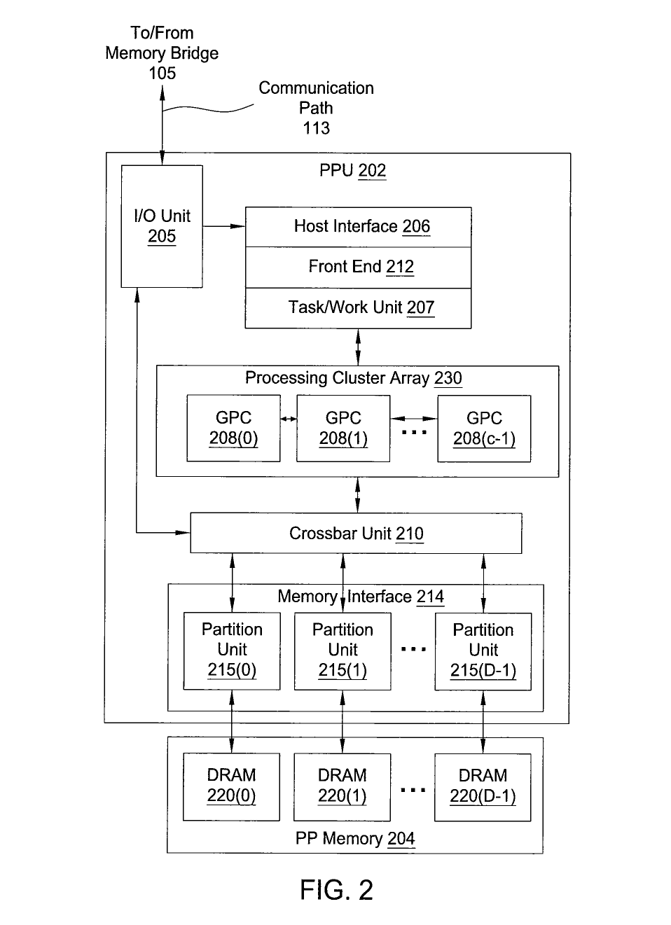

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Coordinating Memory Access Requests

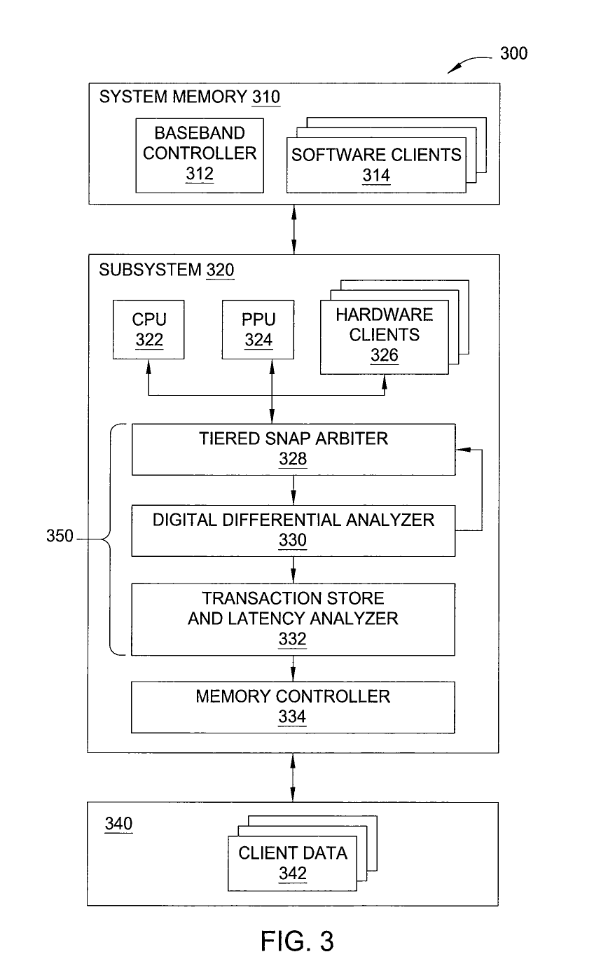

FIG. 3 is a block diagram of a system 300 configured to coordinate memory access requests from various clients, according to one embodiment of the present invention. System 300 may be included within any mobile device, such as a cellular telephone or a tablet computer, may be incorporated into a digital video camera, or may be included within any computer system, such as computer system 100 shown in FIG. 1. As shown, system 300 includes a system memory 310 coupled to a subsystem 320 that, in turn, is coupled to a random access memory (RAM) module 340. RAM module 340 may be a double-data rate (DDR) RAM module or another type of volatile memory module. In one embodiment, RAM module 340 and system memory 310 may each represent different portions of a single memory unit configured to store client applications, client data, and other types of data associated with the operation of system 300 as a whole. System memory 310 stores a baseband controller (BBC 312) and software clients 314. BBC 312 is a software modem configured to establish and maintain network connections, as described in greater detail below. Software clients 314 represent other software entities configured to consume resources associated with system 300 in order to perform various tasks, as needed, by system 300, as also described in greater detail below.

Subsystem 320 may be a system-on-a-chip (SoC) and, thus, may be configured to perform a wide range of different processing operations. Subsystem 320 includes a central processing unit (CPU) 322, a parallel processing unit (PPU) 324, and hardware clients 326. CPU 322 may be a multi-core processing unit or a collection of different processing units, such as two or more processing cores configured to operate in parallel and/or in conjunction with one another. In one embodiment, a processing core within CPU 322 is configured to execute BBC 312 in order to implement the modem functionality mentioned above. PPU 324 may be included within parallel processing subsystem 112 shown in FIG. 1 and may be similar to PPU 202 shown in FIG. 2. PPU 324 may be a graphics processing unit (GPU) configured to perform graphics-oriented computations as well as general-purpose computations. Hardware clients 326 may represent other hardware entities configured to consume resources associated with system 300 in order to perform various tasks, as needed, by system 300.

In the context of this disclosure, BBC 312, software clients 314, CPU 322, PPU 324, and hardware clients 326 are referred to generically as “clients.” Persons skilled in the art will understand that a “client” refers to any hardware or software entity configured to consume resources associated with system 300 in order to perform various tasks, as needed, by system 300.

The clients within system 300 are configured to issue memory access requests to RAM module 340 in order to read from or write to client data 342. For example, BBC 312 may issue a memory access request in order to read access credentials from client data 342 when establishing or maintaining a network connection. Alternatively, PPU 324 may read video data from client data 342 when decoding a video for display. As a general matter, the clients within system 300 may issue memory access requests to RAM module 340 for a wide variety of reasons in order to read from or write to client data 342. In order to coordinate the different memory access requests received from the clients within system 300, subsystem 320 is configured to implement a memory access pipeline 350.

Memory access pipeline 350 is configured to prioritize memory access requests and expedite the processing of certain memory access requests in order to accomplish specific objectives. Those objectives are (i) to provide BBC 312 with sufficient memory bandwidth to enable the timely initiation and maintenance of network connections, and (ii) to prevent other clients within system 300 from experiencing memory bandwidth starvation. Memory access pipeline 350 may accomplish those two objectives by implementing a series of different processing stages, as described in greater detail below.

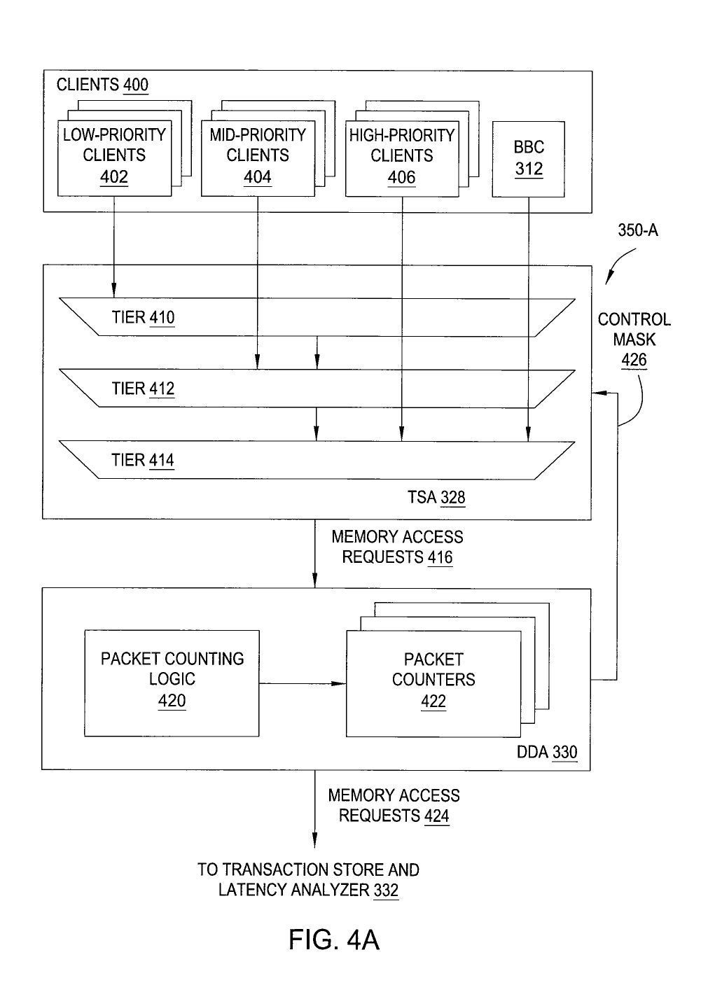

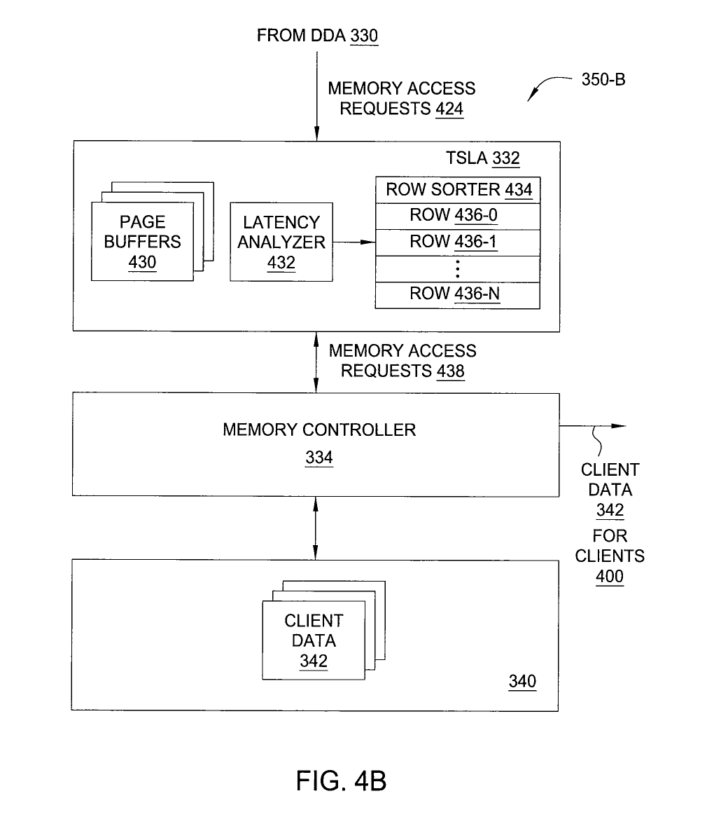

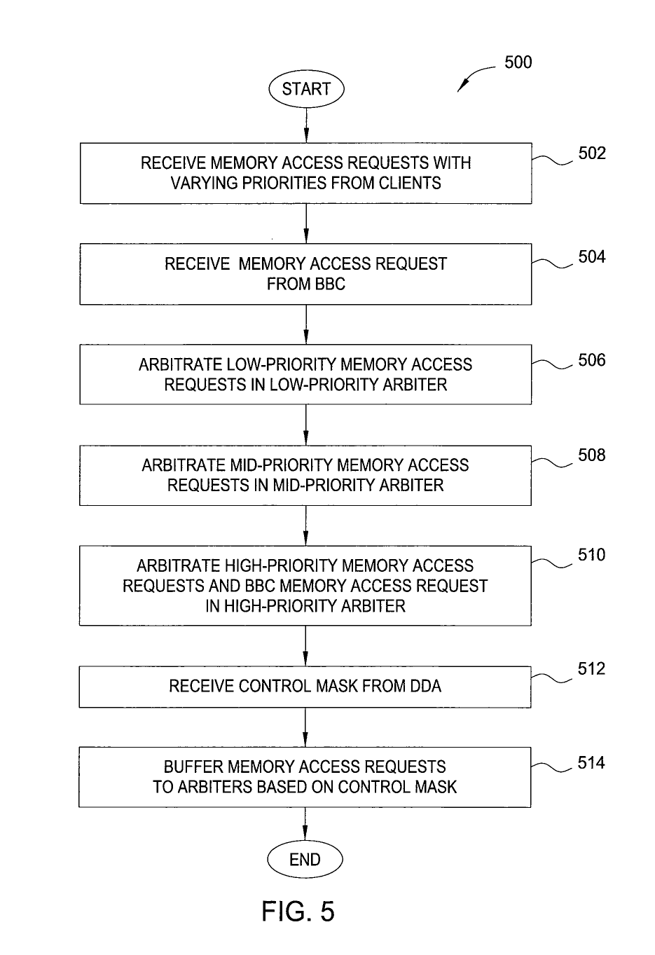

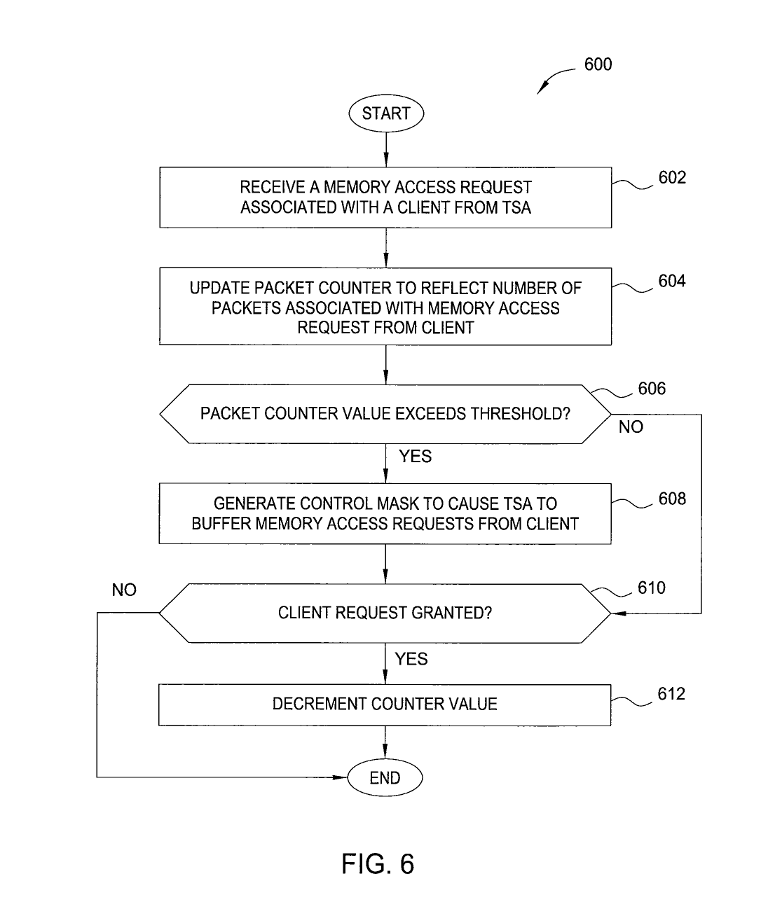

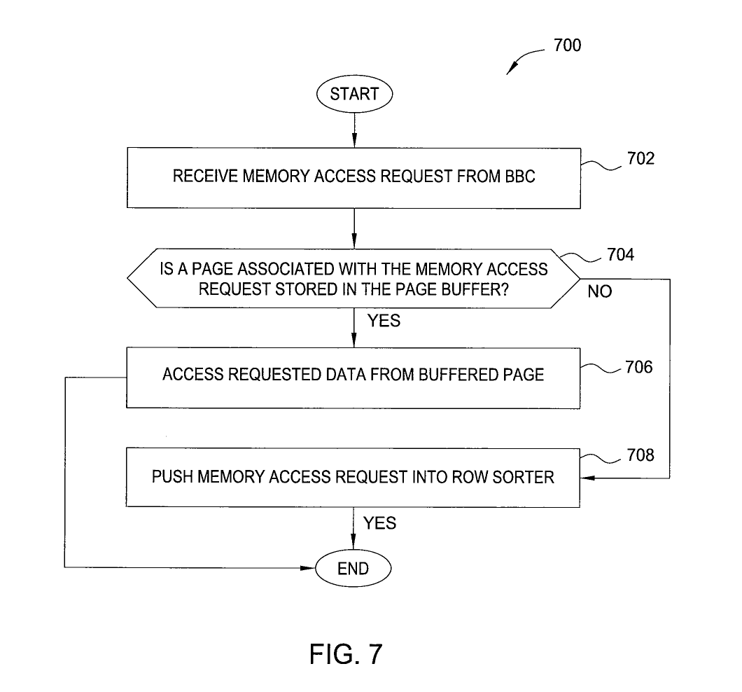

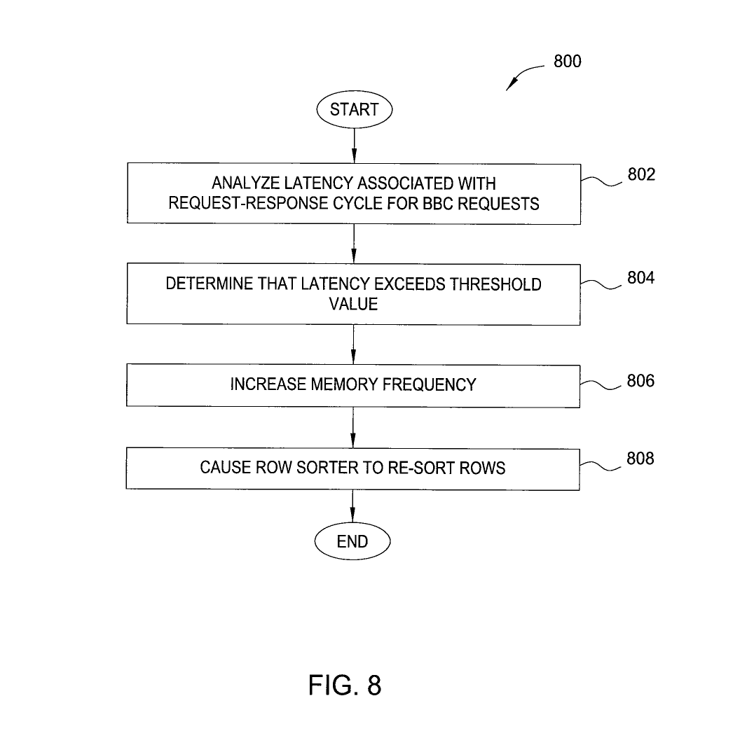

In FIG. 3, memory access pipeline 350 includes a tiered snap arbiter (TSA) 328, a digital differential analyzer (DDA) 330, and a transaction store and latency analyzer (TSLA) 332. TSA 328 is configured to prioritize memory access requests received from the clients within system 300 based on a priority level associated with each such client, as described in greater detail below in conjunction with FIGS. 4A and 5. DDA 330 is configured to monitor the bandwidth consumption associated with each different client and to selectively buffer memory access requests from certain clients when those clients consume excessive bandwidth, as described in greater detail below in conjunction with FIGS. 4A and 6. TSLA 332 is configured to buffer pages on behalf of BBC 312, as described in greater detail below in conjunction with FIGS. 4B and 7. TSLA 332 is also configured to analyze the request-to-response time of memory access requests issued by BBC 312 and to expedite the processing of memory access requests issued by BBC 312 under certain circumstances, as described in greater detail below in conjunction with FIGS. 4B and 8.

Once memory access pipeline 350 has coordinated the memory access requests received from the clients within system 300 via the different units mentioned above, a memory controller 334 coupled to memory access pipeline 350 may issue those requests to RAM module 340 for processing.

FIG. 4A is a more detailed block diagram illustrating TSA 328 and DDA 330 of FIG. 3, according to one embodiment of the present invention. As shown, TSA 328 and DDA 330 reside within a portion 350-A of memory access pipeline 350 described above in conjunction with FIG. 3. Clients 400 are configure to issue memory access requests to TSA 328 within portion 350-A. Clients 400 may include any of the clients discussed above in conjunction with FIG. 3, including BBC 312 (as is shown), as well as software clients 314, CPU 322, PPU 324, and hardware clients 326 (none shown here). Clients 400 may be divided into different priority groupings based on the latency requirements of each such client. As shown, clients 400 include low-priority clients 402, mid-priority clients 404, and high-priority clients 406.

Low-priority clients 402 may include non-isochronous clients with relaxed latency requirements. Memory access requests issued by low-priority clients 402 may generally not need to be processed according to specific time constraints. Mid-priority clients 404 may include isochronous clients with moderate latency requirements. Memory access requests issued by mid-priority clients 404 generally need to be processed within a certain (possibly lengthy) interval of time. High-priority clients 406 may include highly isochronous clients with strict latency requirements. Memory access requests issued by high-priority clients 406 generally need to be processed expeditiously in order to avoid disruption of an important service provided by high-priority clients 406. BBC 312 may be considered a “very high priority client.” Memory access requests issued by BBC 312 generally need to be processed within a very short time interval so that BBC 312 may respond to network events and thus maintain network connections, as mentioned previously.

TSA 328 is configured to receive memory access requests from clients 400 and to route those memory access request to different tiers within TSA 328 according to the priority associated with the client responsible for issuing each such request. As is shown, TSA 328 routes memory access requests issued by low-priority clients 402 to tier 410. Likewise, TSA 328 routes memory access requests issued by mid-priority clients 404 to tier 412, and TSA 328 routes memory access requests issued by high-priority clients 406 to tier 414. In addition, TSA 328 is configured to route memory access requests issued by BBC 312 to tier 414. In the context of this disclosure, tier 410 may be a considered a low-priority tier, tier 412 may be considered a mid-priority tier, and tier 414 may be considered a high-priority tier.

TSA 328 also is configured to perform independent arbitration of the memory access requests included within each tier. In one embodiment, each tier of TSA 328 represents a different arbiter. Upon arbitrating between memory access requests within a given tier, TSA 328 may provide arbitrated memory access requests to a subsequent tier. For example, TSA 328 may arbitrate between memory access requests within tier 410, and then provide arbitrated memory access requests from tier 410 to tier 412. TSA 328 may proceed in this fashion in order to cause all memory access requests to eventually filter down to tier 414 via one or more stages of arbitration. TSA 328 may arbitrate between the memory access requests within tier 414 in order to generate memory access requests 416. TSA 328 outputs memory access requests 416 to DDA 330.

DDA 330 includes packet counting logic 420 and packet counters 422. Packet counting logic 420 is configured to analyze each memory access request 416 and to determine the number of packets associated with each such request, i.e. the number of packets associated with a write to RAM module 340 or the number of packets associated with a read from RAM module 340. For a memory access request issued by a given client 400, packet counting logic 420 is also configured to update a packet counter 422 associated with that client to reflect the total number of packets associated with outstanding requests issued by that client. Thus, the packet counter 422 associated with the given client 400 reflects the total amount of bandwidth that will be consumed by memory access requests issued by that client.

When the packet counter 422 for a given client exceeds a preset threshold value, then DDA 330 is configured to issue a control mask 426 that causes TSA 328 to buffer additional memory access requests issued by that client. When a memory access request issued by the given client is granted, then packet counting logic 420 may decrement the packet counter 422 associated with the given client. The threshold for a given client 400 may be preconfigured based on, e.g., the bandwidth requirements of that client. With this approach, DDA 330 may track the bandwidth consumed by each client and selectively buffer memory access requests issued by clients attempting to consume more than a certain amount of bandwidth. Consequently, DDA 330 may prevent BBC 312 from consuming a disproportionate amount of bandwidth and causing other clients 400 to become starved for bandwidth.

As a general matter, DDA 330 may implement the approach described above for each different client 400, and may thus count and record the number of packets associated with memory access requests issued by each of clients 400. Further, DDA 330 may generate and issue control mask 426 to cause TSA 328 to buffer memory access requests from any number of different clients 400. Specifically, control mask 426 may include a control signal for each different client 400, thereby indicating whether memory access requests associated with each of those different clients 400 should be buffered. Thus, DDA 330 acts as a feedback control mechanism to further enhance the prioritization functionality of TSA 330 by stalling clients that issue memory access requests too frequently.

DDA 330 is configured to provide memory access requests 424 to TSLA 332. The functionality of TSLA 332 is described in greater detail below in conjunction with FIG. 4B.

FIG. 4B is a more detailed block diagram illustrating TSLA 332 of FIG. 3, according to one embodiment of the present invention. TSLA 332 is included within portion 350-B of memory access pipeline 350 shown in FIG. 3. As shown, TSLA 332 includes page buffers 430, latency analyzer 432, and row sorter 434.

TSLA 332 is configured to receive memory access requests 424 from DDA 330. For read requests issued by BBC 312, TSLA 332 is configured to analyze each such request to determine whether the requested data is resident in page buffers 430. If the page that includes the requested data is buffered within page buffers 430, then TSLA 332 may immediately return the requested data to BBC 312. With this approach, data that is frequently needed by BBC 312 may be made available to BBC 312 on short notice. However, for most other memory access requests, including memory access requests issued by other clients 400, write requests issued by BBC 312, and read requests issued by BBC 312 for data that is not resident in page buffers 430, TSLA 332 may process those requests via latency analyzer 432 and row sorter 434, as described herein.

Latency analyzer 432 and row sorter 434 are configured to operate in conjunction with one another. Row sorter 434 is configured to collect memory access requests that target the same pages within RAM module 340 into specific rows 436 within row sorter 434. The memory access requests within a given row 436 may then be issued to memory controller 334 simultaneously so that the page associated with those different requests may remain open between requests, thereby improving memory access efficiency.

Latency analyzer 312 is configured to measure the request-to-response latency for each memory access request issued by BBC 312 and to expedite future memory access requests issued by BBC 312 when that latency exceeds a maximum value. In doing so, latency analyzer 334 may cause row sorter 434 to re-order rows 436 so that rows 436 including memory access requests issued by BBC 312 may be processed before other rows 436 that do not include such requests. Latency analyzer 432 may also expedite requests issued by BBC 312 by temporarily increasing the frequency of memory controller 334 and/or RAM module 340 in order to cause those units to handle memory access requests more quickly.

TSLA 332 is configured to issue memory access requests 438 to memory controller 334. Memory controller 334 may then read data from or write data to client data 342 within RAM module 340 according to those requests. In doing so, memory controller 334 may return portions of client data 342 to clients 400.

By implementing the various techniques described thus far in conjunction with one another, memory access pipeline 350 is capable of providing BBC 312 with sufficient memory bandwidth to enable the timely initiation and maintenance of network connections. Additionally, memory access pipeline 350 may also prevent clients within system 300 from experiencing memory bandwidth starvation. Thus, BBC 312 does not require separate DRAM or a separate DRAM interface in order to maintain network connectivity.

FIG. 5 is a flow diagram of method steps for arbitrating memory access requests from multiple clients, according to one embodiment of the present invention. Although the method steps are described in conjunction with the systems of FIGS. 1-4B, persons skilled in the art will understand that any system configured to perform the method steps, in any order, is within the scope of the present invention.

As shown, a method 500 begins at step 502, where TSA 328 receives a set of memory access requests with varying priorities from clients 400. Each one of clients 400 may have a different priority, and the priority of a memory access request issued by a given client is derived from the priority of that client. At step 504, TSA 328 receives a set of memory access requests from BBC 312. In the context of this disclosure, BBC 312 may be considered a “very high priority client.”

At step 506, TSA 328 arbitrates low-priority memory access requests in a low-priority arbiter. The low-priority arbiter may be tier 410 of TSA 328. At step 508, TSA 328 arbitrates mid-priority memory access requests in a mid-priority arbiter. The mid-priority arbiter may be tier 412 of TSA 328. At step 508, TSA 328 arbitrates high-priority memory access requests and memory access requests issued by BBC 312 in a high-priority arbiter. The high-priority arbiter may be tier 414 of TSA 328.

At step 510, TSA 328 receives a control mask from DDA 330. The control mask includes a control signal for each different client 400. A given control signal indicates whether memory access requests issued by the corresponding client should be buffered. Memory access requests issued by a given client should be buffered when that client issues an excessive number of memory access requests, as determined by DDA 330. The functionality of DDA 330 is described in greater detail below in conjunction with FIG. 6. At step 512, TSA 328 buffers memory access requests associated with specific clients, as indicated by the control mask received from DDA 330 at step 510. The method then ends.

By implementing the approach described above, TSA 328 may prioritize memory access requests issued by clients 400 according to a priority level associated with each such client, while ensuring that BBC 312 is given a high priority. Additionally, by selectively buffering memory access requests from certain clients, including BBC 312, based on the control mask received from DDA 330, TSA 328 may prevent specific clients from consuming excessive bandwidth.

FIG. 6 is a flow diagram of method steps for generating a control mask that causes a TSA to buffer memory access requests from certain clients, according to one embodiment of the present invention. Although the method steps are described in conjunction with the systems of FIGS. 1-4B, persons skilled in the art will understand that any system configured to perform the method steps, in any order, is within the scope of the present invention.

As shown, a method 600 begins at step 602, where DDA 330 receives a memory access request from a client 400. The client could be, e.g. BBC 312 or another one of clients 400. At step 604, packet counting logic 420 within DDA 330 updates a packet counter 322 associated with the client 400 based on a number of packets associated with the memory access request. The number of packets could be, for example, a number of packets associated with a read from RAM module 340 or a number of packets associated with a write to RAM module 340. The packet counter 422 associated with the client 400 generally indicates the total amount of bandwidth that will be consumed by memory access requests issued by the client 400 when those requests are granted.

At step 606, DDA 330 determines whether the value of the packet counter 422 exceeds a threshold value. The threshold value reflects a maximum allowable number of packets associated with outstanding memory access requests issued by the client. If DDA 330 determines at step 606 that the packet counter 422 exceeds the threshold value, then the method proceeds to step 608. At step 608, DDA 330 generates a control mask that indicates that memory access requests from the client 400 should be buffered. DDA 330 is configured to transmit the control mask to TSA 328. The control mask could be, e.g., control mask 426 shown in FIG. 4A. TSA 328 may receive the control mask and then buffer memory access requests issued by the client 400 indicated within the control mask, as described above in conjunction with FIG. 5.

If DDA 330 determines at step 606 that the packet counter 422 does not exceed the threshold value, then the method proceeds to step 610. At step 610, DDA 330 determines whether any outstanding memory access requests associated with the client 400 have been granted. If no outstanding memory access requests have been granted, then the method 600 ends. Otherwise, if DDA 330 determines at step 610 that an outstanding memory access request has been granted, then the method 600 proceeds to step 612. At step 612, DDA 330 decrements the packet counter 422. The method 600 then ends. DDA 330 may repeat the method 600 with each memory access request received from the client 400.

With the approach described above, DDA 330 is capable of tracking the bandwidth that will be consumed by various clients 400 when memory access requests associated with those clients are granted. Accordingly, DDA 330 may stall certain clients when those clients request excessive bandwidth, thereby avoiding situations where other clients 400 become starved for bandwidth. The memory access requests analyzed by DDA 330 are passed to TSLA 332, as described in greater detail below in conjunction with FIG. 7.

FIG. 7 is a flow diagram of method steps for handling a memory access request from a BBC, according to one embodiment of the present invention. Although the method steps are described in conjunction with the systems of FIGS. 1-4B, persons skilled in the art will understand that any system configured to perform the method steps, in any order, is within the scope of the present invention.

As shown, a method 700 begins at step 702, where TSLA 332 receives a memory access request from BBC 312. At step 704, TSLA 332 determines whether the page associated with the memory access request is stored within page buffers 430. If TSLA 332 determines that the page associated with the memory access request is stored within page buffers 430, then the method 700 proceeds to step 706, where TSLA 332 accesses the requested data from the buffered page. The method 700 then ends.

If at step 704, TSLA 332 determines that the page associated with the memory access request is not stored within page buffers 430, then the method 700 proceeds to step 708. At step 708, TSLA 332 pushes the memory access request into row sorter 434. The method 700 then ends. The inter-operation of row sorter 434 with latency analyzer 432 is described in greater detail below in conjunction with FIG. 8.

FIG. 8 is a flow diagram of method steps for decreasing the latency associated with memory access requests from a BBC 312, according to one embodiment of the present invention. Although the method steps are described in conjunction with the systems of FIGS. 1-4B, persons skilled in the art will understand that any system configured to perform the method steps, in any order, is within the scope of the present invention.

As shown, a method 800 begins at step 802, where latency analyzer 432 analyzes the latency associated with the request-to-response cycle for memory access requests associated with BBC 312. Latency analyzer 432 could, for example, compare the time when a memory access request was issued by BBC 312 to the time when the memory access request was actually granted. At step 804, latency analyzer 332 determines that the request-to-response time latency exceeds a threshold value. The threshold value may indicate the maximum amount of time that BBC 312 is capable of waiting for memory access requests to be satisfied.

At step 806, latency analyzer 432 increases the frequency of memory controller 334 and/or RAM module 340. Memory controller 334 and RAM module 340 may then handle memory access requests more expeditiously. At step 808, latency analyzer 432 causes row sorter 434 to re-sort rows 436 so that rows including memory access requests issued by BBC 312 will be processed before other rows 436 that do not include such requests. In one embodiment, latency analyzer 806 optionally performs either of steps 806 or 808. The method 800 then ends.

In sum, a memory access pipeline within a subsystem is configured to manage memory access requests that are issued by clients of the subsystem. The memory access pipeline is capable of providing a software baseband controller client with sufficient memory bandwidth to initiate and maintain network connections. The memory access pipeline includes a tiered snap arbiter that prioritizes memory access requests. The memory access pipeline also includes a digital differential analyzer that monitors the amount of bandwidth consumed by each client and causes the tiered snap arbiter to buffer memory access requests associated with clients consuming excessive bandwidth. The memory access pipeline also includes a transaction store and latency analyzer configured to buffer pages associated with the baseband controller and to expedite memory access requests issued by the baseband controller when the latency associated with those requests exceeds a pre-set value.

Advantageously, the baseband controller does not require separate memory or a separate memory interface in order to acquire sufficient memory bandwidth to initiate and maintain network connections. Accordingly, the disclosed subsystem may have a reduced size as well as decreased power requirements compared to prior art designs.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A computer-implemented method for coordinating memory access requests issued by a plurality of clients, the method comprising:
receiving a first memory access request from a first client included in the plurality of clients, wherein the first client is configured to initiate and maintain a network connection between a computing device that includes the plurality of clients and a network external to the computing device;
receiving a second memory access request from a second client included in the plurality of clients;
determining an order for servicing the first memory access request and the second memory access request;
causing a memory unit to access a first portion of data to process the first memory access request according to the order; and
causing the memory unit to access a second portion of data to process the second memory access request according to the order.

2. The computer-implemented method of claim 1, wherein determining the order for servicing the first memory access request and the second memory access request comprises:
determining a first priority level associated with the first client;
determining a second priority level associated with the second client that is lower than the first priority level;
associating the first memory access request with the first priority level;
associating the second memory access request with the second priority level; and
ordering the first memory access request and the second memory access request for servicing based on the first priority level and the second priority level.

3. The computer-implemented method of claim 1, further comprising:
determining that a first packet counter associated with the first client exceeds a threshold value, wherein the first packet counter reflects an amount of data associated with one or more outstanding memory access requests issued by the first client; and
generating a first control mask that indicates that at least one memory access request associated with the first client should be buffered.

4. The computer-implemented method of claim 3, further comprising:
determining that an outstanding memory access request issued by the first client has been serviced;
decrementing the first packet counter;
determining that the first packet counter does not exceed the threshold value; and
generating a second control mask that indicates that the at least one memory access request associated with the first client should no longer be buffered.

5. The computer-implemented method of claim 1, further comprising:
identifying a first memory page that includes the first portion of data;
determining that the first memory page is stored within a page buffer;
retrieving the first portion of data from the page buffer; and
returning the first portion of data to the first client.

6. The computer-implemented method of claim 1, further comprising:
determining that a request-to-response time associated with a completed memory access request previously issued by the first client exceeds a threshold value; and
in response, expediting the accessing of the first portion of data.

7. The computer-implemented method of claim 6, wherein expediting the accessing of the first portion of data comprises increasing the clock frequency of the memory unit.

8. The computer-implemented method of claim 6, wherein expediting the accessing of the first portion of data comprises:
adding the first memory access request to a first row within a row sorter, wherein the first row is associated with the first memory page; and
causing the row sorter to re-order the first row and one or more additional rows so that memory access requests included in the first row are processed before memory access requests in the one or more additional rows.

9. A subsystem configured to coordinate memory access requests issued by a plurality of clients, including:
a tiered snap arbiter configured to:
receive a first memory access request from a first client included in the plurality of clients, wherein the first client is configured to initiate and maintain a network connection between a computing device that includes the plurality of clients and a network external to the computing device;
receive a second memory access request from a second client included in the plurality of clients;
determine an order for servicing the first memory access request and the second memory access request;
cause a memory unit to access a first portion of data to process the first memory access request according to the order; and
cause the memory unit to access a second portion of data to process the second memory access request according to the order.

10. The subsystem of claim 9, wherein the tiered snap arbiter determines the order for servicing the first memory access request and the second memory access request by:
determining a first priority level associated with the first client;
determining a second priority level associated with the second client that is lower than the first priority level;
associating the first memory access request with the first priority level;
associating the second memory access request with the second priority level; and
ordering the first memory access request and the second memory access request for servicing based on the first priority level and the second priority level.

11. The subsystem of claim 9, further including:
a digital differential analyzer configured to:
determine that a first packet counter associated with the first client exceeds a threshold value, wherein the first packet counter reflects an amount of data associated with one or more outstanding memory access requests issued by the first client; and
generate a first control mask that indicates to the tiered snap arbiter that at least one memory access request associated with the first client should be buffered.

12. The subsystem of claim 11, wherein the digital differential analyzer is further configured to:
determine that an outstanding memory access request issued by the first client has been serviced;
decrement the first packet counter;
determine that the first packet counter does not exceed the threshold value; and
generate a second control mask that indicates that the at least one memory access request associated with the first client should no longer be buffered.

13. The subsystem of claim 9, further including:
a page buffer configured to:
identify a first memory page that includes the first portion of data;
determine that the first memory page is stored within a page buffer;
retrieve the first portion of data from the page buffer; and
return the first portion of data to the first client.

14. The subsystem of claim 9, further including:
a latency analyzer configured to:
determine that a request-to-response time associated with a completed memory access request previously issued by the first client exceeds a threshold value; and
in response, expedite the accessing of the first portion of data.

15. The subsystem of claim 14, wherein the latency analyzer expedites the accessing of the first portion of data by increasing the clock frequency of the memory unit.

16. The subsystem of claim 14, wherein the latency analyzer expedites the accessing of the first portion of data by:
adding the first memory access request to a first row within a row sorter, wherein the first row is associated with the first memory page; and
causing the row sorter to re-order the first row and one or more additional rows so that memory access requests included in the first row are processed before memory access requests in the one or more additional rows.

17. A computing device configured to coordinate memory access requests issued by a plurality of clients, including:
a processing unit configured to:
receive a first memory access request from a first client included in the plurality of clients, wherein the first client is configured to initiate and maintain a network connection between a computing device that includes the plurality of clients and a network external to the computing device;
receive a second memory access request from a second client included in the plurality of clients;
determine an order for servicing the first memory access request and the second memory access request;
cause a memory unit to access a first portion of data to process the first memory access request according to the order; and
cause the memory unit to access a second portion of data to process the second memory access request according to the order.

18. The computing device of claim 17, further including:
a memory coupled to the processing unit and storing program instructions that, when executed by the processing unit, cause the processing unit to:
receive the first memory access request;
receive the second memory access request;
determine the order for servicing the first memory access request and the second memory access request;
cause the memory unit to access the first portion of data; and
cause the memory unit to access the second portion of data.

19. The computing device of claim 17, wherein the processing unit is further configured to:
determine that a first packet counter associated with the first client exceeds a threshold value, wherein the first packet counter reflects an amount of data associated with one or more outstanding memory access requests issued by the first client; and
generate a first control mask that indicates to the tiered snap arbiter that at least one memory access request associated with the first client should be buffered.

20. The computing device of claim 17, wherein the processing unit is further configured to:
determine that a request-to-response time associated with a completed memory access request previously issued by the first client exceeds a threshold value; and
in response, expedite the accessing of the first portion of data.
